(19) United States
(12) Patent Application Publication
(10) Pub. No.: US 2023/0034496 A1
(43) Pub. Date: Feb. 2, 2023

(54) CHITIN REGENERATIVE HYDROGEL AND PREPARATION METHOD AND APPLICATION THEREOF

(71) Applicant: SUN YAT-SEN UNIVERSITY, Guangzhou (CN)

(72) Inventors: Liming ZHANG, Guangzhou (CN); Lizhi DENG, Guangzhou (CN)

(73) Assignee: SUN YAT-SEN UNIVERSITY, Guangzhou (CN)

(21) Appl. No.: 17/964,052

(22) Filed: Oct. 12, 2022

(51) Int. Cl. C08J 3/075; H01G 11/62; H01G 11/84

(52) U.S. Cl. CPC C08J 3/075; H01G 11/62; H01G 11/84; C08J 2305/08

(57) ABSTRACT

The present invention discloses a chitin regenerative hydrogel and a preparation method and application thereof, which belong to the technical field of energy materials. The preparation method of the chitin regenerative hydrogel comprises the following steps: 1, performing heating dissolution and cooling molding on chitin and ionic liquid to obtain chitin-ionic liquid gel; and S2, soaking the chitin-ionic liquid gel into alkaline solution to obtain the chitin regenerative hydrogel. The chitin-ionic liquid gel and the chitin regenerative hydrogel that are prepared in the present invention have good restoring capacity and thixotropy capacity. The chitin-ionic liquid gel is soaked into potassium hydroxide aqueous solution for replacement to obtain the chitin-based regenerative hydrogel, the chitin-based regenerative hydrogel is taken as a polymer electrolyte diaphragm for assembling a supercapacitor, and the obtained capacitor has higher specific capacitance and charging/discharging efficiency, and good rate capability and reversibility.

### TECHNICAL FIELD

The present invention belongs to the technical field of energy materials, and particularly relates to a chitin regenerative hydrogel and a preparation method and application thereof.

### BACKGROUND

Chitin, also called as chitosan and chitosan, is a second largest renewable resource in nature, which is only next to cellulose in reserves, has an annual output of more than 1 billion tons and widely exists in lower algae, fungal cells, arthropod exoskeletons, shells of crustaceans and cuticles of insects. Due to the strong hydrogen-bond interaction in chitin molecules, the chitin has very high crystallinity in a solid state, leading to that the chitin is extremely difficult to dissolve in water and general organic solvents, thereby limiting the application of the chitin.

At present, chitin is dissolved by using the interaction between the chitin and inorganic solvents or organic solvents mainly. Weimarn et al. have reported that chitin is dissolved through strong hydration of inorganic salts such as LiCNS, Ca(CNS)₂, CaCl₂), CaBr₂, CaCl₂) and the like and pointed out that the solubility thereof decreases sequentially (Weimarn, Conversion of Fibroin, Chitin, Casein and Similar Substances into the Ropy-Plastic State and Colloidal Solution, Industrial and Engineering Chemistry, 1927, 19(1), 109-110). Clark and Smith dissolved chitin in supersaturated lithium sulfocyanide solution, and the dissolving temperature was 95° C. (Clark, X-ray diffraction studies of chitin, chitosan and derivatives, Journal of Physical Chemistry, 1936, 40(7), 863-879). Vincendon studied chitin dissolved in saturated LiCNS solution and a LiCl/amide system by using nuclear magnetic resonance, and results showed that a strong ionic interaction exists between an N-acetyl amino group and a lithium ion (Li⁺) on a chitin molecule, so that a complex can be formed, which greatly weakens the hydrogen-bond interaction of chitin molecule and contributes to solution thereof (Marc Vincendon, ¹H NMR study of the chitin dissolution mechanism, Die Makromolekulare Chemie, 1985, 186(9), 1787-1795). In addition, LiCl/DMAc, LiCl/DMF and LiCl/NMP developed on the basis are all benign solvents which are widely applied at present and have no degradation effect on chitin.

Similar to the lithium ion, calcium ion (Ca²⁺) can also form a cationic complex with the chitin, so as to be dissolved into the organic solvents. Tamura has done extensive researches on that the chitin is dissolved by a CaCl₂)/methanol system and showed that the water content and the concentration of Ca²⁺ have important influence on the dissolution of the chitin, and the higher the deacetylation degree of the chitin is, the easier the dissolution in the solvent is (Tamura, Preparation of chitin hydrogel under mild conditions, Polymer Preprints, 2006, 55, 1862). Compared with the lithium ion, the calcium ion is lower in toxicity, which is a better optional solvent used for dissolving the chitin, but the solution formed after the dissolution of the chitin is too viscous, which is not suitable for mass production. The reason of generating the phenomenon may be that: when the chitin is dissolved by using the organic solvent containing active metal ions, generally the active metal ions are firstly complexed with an amino group on the chitin to form a cationic complex, and then the cationic complex is dissolved into amide or alcohol organic solvents. In other words, the true solvent is the organic solvent; and after the cationic complex formed by the chitin and the active metal ions is dissolved into the organic solvent, a viscosity phenomenon is generated as the concentration of the solution is too large.

In order to solve the above problems, studies have found that the chitin is dissolved into high concentration inorganic acid (such as hydrochloric acid, nitric acid and phosphoric acid) and organic acid (such as DCA and TCA), or the chitin is dissolved into a mixed solvent prepared from halohydrin (chlorohydrin and chloroisopropyl alcohol) and strong acid, so that the viscosity of the solution is decreased; but the chitin is hydrolyzed strongly, leading to reduction in molecular weight, and the mechanical property of fibers or films prepared becomes poor. Further, the acid solvent has corrosivity, the use of halohydrin causes pollution to the environment, and therefore, the types of solvents are not suitable for large-scale application. Additionally, the solubility of the chitin can be enhanced by using HFP, HFAS, methanesulfonic acid and other strong polar solvents. The patent JP23246482A discloses production methods of a chitosan fiber and a thin film, wherein the patent discloses that chitin is dissolved by using HFP or HFAS, and the fiber can be obtained through hygrometric state spinning, or the paved films can serve as absorbable surgical sutures and other medical materials. As the chitin can be degraded by enzyme in viable tissues and can resist hydrolysis, the chitin can be used for preparing a surgical article which has good reservation under different conditions.

Since 2000, the Zhang Lina research group from Wuhan University has found that NaOH/urea, NaOH/thiourea, LiOH/urea aqueous solution systems have good dissolution effect on cellulose and prepared a series of novel materials based on the cellulose (Cai Jie, Biomacromolecules, 2006, 7, 183-189). As the chitin and the cellulose have similar molecular structures, in 2007, Du Yumin et al. firstly used the NaOH/urea aqueous solution for dissolving the chitin and researched the property of dissolved dilute solution; and the result found that the addition of urea can improve the stability of the solution, the chitin has the best dissolution condition in the mixed solution of NaOH with the concentration of 8 wt % and urea with the concentration of 4 wt % at −20° C., and the solution can form a gel state when the temperature is raised. The low temperature dissolution mechanism of the chitin is that: the low temperature chitin and a NaOH hydrate can form a hydrogen bond ligand, and meanwhile, the urea and NaOH are combined and then are coated outside the hydrogen bond ligand, so as to form a clathrate compound; the compound formed through driving of a hydrogen bond has a stabler state at low temperature, therefore, the chitin can achieve low temperature dissolution, and the formed solution has great development potential (Hu Xianwen, Solubility and property of chitin in NaOH/urea aqueous solution, Carbohydrate Polymers, 2007, 70, 451-458).

Ionic liquid, also called as room temperature ionic liquid, is a type of molten salt which is composed of cations and anions and is in a liquid state at room temperature or at the temperature close to room temperature. Common cations for forming the ionic liquid include quaternary ammonium salt ions, quaternary phosphonium salt ions, imidazolium salt ions, pyridinium ions and other ions with larger volume; and the anions mainly include halide ions, fluorine-containing anions, acid group anions and the like. Compared with the traditional solvent, the ionic liquid has unique performances: (1) the steam pressure is low; and the ionic liquid is uneasy in volatilization in the heating process, high in safety coefficient in operation and little in environmental pollution; (2) the solubility is good; and the ionic liquid is a good solvent of a lot of organic compounds, inorganic substances and metallo-organic compounds; (3) the melting point is low, and the thermal stability is good; and the melting point of the commonly used ionic liquid is lower than 100° C.; (4) the electrical conductivity is strong; and as an ionic type solvent, the ionic liquid has own electrical conductivity, and the electrical conductivity is 0.1-14 mS/cm; and (5) the ionic liquid has adjustability; and the density, the viscosity and other physical properties of the solvent can be adjusted by changing the composition and structure of the ionic liquid. As a novel solvent, the ionic liquid is widely applied to catalyzed synthesis of fuel cells, solar cells and so on, and new uses are developed constantly.

The dissolution mechanism of the chitin in the ionic liquid is similar to the dissolution mechanism of the cellulose in the ionic liquid, both of which are that the chitin and the cellulose are dissolved by destroying a hydrogen bond network in molecules or between molecules. When dissolution behaviors of the cellulose, the chitin and other natural polysaccharides in the ionic liquid are researched, people found that when the concentration of the polysaccharide exceeds a certain critical concentration, the natural polysaccharide/ionic liquid system generally has the sol-gel transformation. After the ionic liquid in an ionic gel component is eluted by water or ethanol, the remaining polysaccharide can form corresponding hydrogel or ethanol gel, and a lot of polysaccharide-based functional materials can be prepared by utilizing the point.

A supercapacitor (an electrochemical double layer capacitor) is an electrochemical capacitor with high energy density, and the energy density thereof is much higher than that of the traditional capacitor; and the cycle life, the power density, the charging/discharging efficiency and other performances thereof are superior to those of a secondary cell. Therefore, the supercapacitor has the advantages of two types of energy storage equipment: the traditional capacitor and the secondary cell, and the performances of the supercapacitor are between the performances of the traditional capacitor and the performances of the secondary cell, which is hopeful to fill up blanks of the traditional capacitor and the secondary cell in application fields.

The supercapacitor comprises three parts: an electrode, a diaphragm and an electrolyte. The material of the electrode mainly comprises carbon materials, transition metal oxides and conductive polymers. The electrolyte mainly comprises a liquid state electrolyte and a solid state electrolyte. The solid state electrolyte gradually becomes the emphasis researched by people due to the advantages that the solid state electrolyte is small and convenient, and safe and leak-free. The solid state electrolyte takes a polymer as a matrix and comprises three types: a full solid state electrolyte, a gel polymer electrolyte and a composite polymer electrolyte. The basic materials of a hydrogel polymer electrolyte used for the supercapacitor mainly comprise polyoxyethylene, potassium polyacrylate, polyvinyl alcohol and the like.

The chitin is a natural polymer which is broad in source and low in price and is easy to get, can be used as a substitute material of a petrochemical engineering-based synthetic polymer, has the characteristics of being good in biocompatibility, being degradable and the like and has great application value. The ionic liquid, serving as a novel green solvent of the chitin, cannot generate volatile substances and has no pollution to the environment when the chitin is dissolved by the ionic liquid; and the problems of the degradation of the chitin and the decrease of the molecular weight caused in the process of dissolving the chitin by the traditional solvent can be effectively avoided. In other words, the chitin is dissolved into the ionic liquid for preparing a novel material is a green and environmentally friendly process. Enhancement on the study on the rheological property of chitin/ionic liquid gel can provide the effective theoretical support for studies on molding and processing of the chitin, preparation of new materials and so on, which has the significance of exploring the application of the regenerative chitin in the energy field.

However, at present, there is no related research on the preparation of chitin regenerative hydrogel with chitin and ionic liquid and the assembling of a super-battery by making the chitin regenerative hydrogel into a polymer electrolyte diaphragm.

### SUMMARY

A principal purpose of the present invention is to provide a preparation method of chitin regenerative hydrogel in order to overcome the defects of the prior art.

Another purpose of the present invention is to provide the chitin regenerative hydrogel and application thereof.

The above purposes of the present invention are realized by the following technical solution:

The preparation method of the chitin regenerative hydrogel comprises the following steps:

S1, performing heating dissolution and cooling molding on chitin and ionic liquid to obtain chitin-ionic liquid gel;

S2, soaking the chitin-ionic liquid gel into alkaline solution to obtain the chitin regenerative hydrogel.

In the step S1, the chitin is dry chitin.

in the step S1, the chitin is from at least one of shrimp shells and crab shells; preferably, the chitin is from the shrimp shells; and more preferably, the chitin is from the shrimp shells with the degree of deacetylation of above 95%.

The chitin is a natural polymer biological material which abounds in nature, is low in price, is easy to get and is biodegradable; and when the chitin is taken as the raw material, more cost is saved, and safety and environmental protection are realized.

In the step S1, the ionic liquid is at least one of 1-Butyl-3-MethylImidazolium Acetate ([BMIM]Ac), 1-Ethyl-3-MethylImidazolium Acetate ([EMIM]Cl) and 1-Allyl-3-methylimidazolium bromide ([AMM]Br); and preferably, the ionic liquid is 1-Butyl-3-MethylImidazolium Acetate.

1-Butyl-3-MethylImidazolium Acetate ([BMIM]Ac) is ionic liquid which is low in steam pressure and is non-volatile; and when the 1-Butyl-3-MethylImidazolium Acetate ([BMIM]Ac) is taken as a solvent, the solvent is greener and more environmentally friendly.

In the step S1, the ionic liquid is preprocessed ionic liquid.

The preprocessing of the ionic liquid refers to that oil bath heating, dehydration and deoxygenization are sequentially performed on the ionic liquid.

The conditions of oil bath heating of the ionic liquid are: the temperature is 80-120° C., and the time is 8-12 min; and preferably, the temperature is 100° C., and the time is 10 min.

A method for performing dehydration and deoxygenization on the ionic liquid can be selected according to the actual requirement, so long as moisture and oxygen in the ionic liquid can be fully removed; and preferably, twin exhaust pipes are utilized for repeated air exhaust and air inflation, so as to remove the moisture and the oxygen in the ionic liquid.

In the step S1, the mass ratio of the chitin and the ionic liquid is 0.5-5:100; and preferably, the mass ratio is 1.5-3:100.

In the step S1, the heating is oil bath heating.

The temperature of oil bath heating is 60-80° C., and the time of oil bath heating is 1-3 h, so that the chitin has good dissolution effect, and the molecular structure of the chitin is protected from being destroyed; and preferably, the temperature of oil bath heating is 70-80° C., and the time of oil bath heating is 2-3 h.

In the step S1, the dissolution is stirring dissolution.

The stirring can be mechanical stirring or manual stirring which is selected according to the actual requirement specifically, so as to achieve the purpose of fully dissolving the chitin.

In the step S1, the cooling molding refers to that the chitin ionic solution obtained after stirring is put into a vessel for natural cooling; and preferably, the chitin ionic solution obtained after stirring is poured into a culture vessel, and the culture vessel is put into a dryer for natural cooling.

In the step S2, the chitin-ionic liquid gel is chitin-ionic liquid gel without containing ionic liquid on the surface.

A method for removing the ionic liquid on the surface of the chitin-ionic liquid gel comprises: firstly, soaking a gel film prepared into an alcohol solvent to remove most ionic liquid on the surface of the chitin-ionic liquid gel, and then soaking the gel film into water to thoroughly remove the ionic liquid on the surface of the chitin-ionic liquid gel.

The alcohol solvent is ethanol; and preferably, the alcohol solvent is anhydrous ethanol.

The time of soaking with the alcohol solvent is 0.5-2 h; preferably, the time of soaking is 1-2 h; and more preferably, the time of soaking is 2 h.

The water is at least one of deionized water, ultrapure water and distilled water; and preferably, the water is deionized water.

The time of soaking with the water is 12-24 h.

In the step S2, the alkaline solution is at least one of potassium hydroxide solution, LiOH solution and sodium hydroxide solution; and preferably, the alkaline solution is potassium hydroxide aqueous solution.

In the step S2, the concentration of the alkaline solution is 3-8 M; and preferably, the concentration is 4-6 M.

The criterion of the adding amount of the alkaline solution is that the chitin-ionic liquid gel can be immersed into the alkaline solution.

In the step S2, soaking treatment is performed in a vacuum environment, and the chitin is soaked into the alkaline solution.

The time of soaking treatment is 2-4 h; and preferably, the time of soaking treatment is 2-3 h.

Specifically, as a preferable manner thereof, a preparation method of chitin regenerative hydrogel comprises the following steps:

S1, putting 1-butyl-3-methylimidazolium acetate into an eggplant-shaped flask, performing oil bath heating and performing repeated air exhaust and air inflation to remove moisture and oxygen with twin exhaust pipes; quickly adding dry chitin into the above flask, performing oil bath heating and stirring for a few hours, so as to obtain clear and bright chitin ionic solution; and pouring the chitin ionic solution into a culture vessel and putting the culture vessel into a dryer for natural cooling, so as to obtain chitin-ionic liquid gel;

S2, soaking the gel prepared into ethanol for 2 h to remove most ionic liquid; then soaking the chitin-ionic liquid gel into deionized water to thoroughly remove the ionic liquid; cutting a thin film into a wafer with the suitable size; and soaking the wafer into potassium hydroxide solution in a vacuum environment, so as to obtain the chitin regenerative hydrogel.

The chitin regenerative hydrogel is prepared by adopting the above preparation method.

Application of the chitin regenerative hydrogel in an energy material is provided.

Application of the chitin regenerative hydrogel in a polymer electrolyte is provided.

A supercapacitor takes the chitin regenerative hydrogel as the polymer electrolyte.

The supercapacitor is assembled by the polymer electrolyte which is the chitin regenerative hydrogel thin film prepared by the chitin regenerative hydrogel prepared in the present application, and an activated carbon electrode plate prepared from TF-supercapacitor activated carbon and a conductive additive: Timcal graphite.

The mass ratio of the TF-supercapacitor activated carbon, the Timcal graphite and PTFE can be selected according to the actual requirement and is 85:10:5 preferably.

Compared with the prior art, the present invention has the following advantages and beneficial effects that:

(1) The chitin-ionic liquid gel and the chitin regenerative hydrogel that are prepared in the present invention have good restoring capacity and thixotropy capacity.

(2) The chitin-ionic liquid gel is soaked into potassium hydroxide aqueous solution for replacement to obtain the chitin-based regenerative hydrogel, the chitin-based regenerative hydrogel is taken as a polymer electrolyte diaphragm for assembling the supercapacitor, and the obtained capacitor has higher specific capacitance and charging/discharging efficiency, and good rate capability and reversibility; and therefore, the chitin-based regenerative hydrogel has good research value and application prospect in the field of supercapacitors.

### BRIEF DESCRIPTION OF DRAWINGS

FIG. 1 shows strain step curve charts of chitin/[BMIM]Ac gel with the chitin contents of 1 wt %, 1.5 wt %, 2 wt % and 3 wt % respectively;

FIG. 2 shows cyclic voltammetry curve charts of regenerative chitin hydrogel with the chitin content of 2 wt % and a commercial aqueous diaphragm made of a PP/PE material;

FIG. 3 shows alternating-current impedance curve charts of regenerative chitin hydrogel with the chitin contents of 1.5 wt %, 2 wt % and 3 wt % respectively and the commercial aqueous diaphragm made of the PP/PE material; and

FIG. 4 is a diagram (a) of rate capability of the regenerative chitin hydrogel with the chitin content of 2 wt % and the commercial aqueous diaphragm made of the PP/PE material and a diagram (b) of a changing curve of discharge capacity in a cyclic process, wherein a is charging and discharging curve charts of a regenerative hydrogel diaphragm with the chitin content of 2 wt % and the commercial aqueous diaphragm made of the PP/PE material under different working current densities; b is a changing diagram of discharge capacity after a capacitor with the chitin content of 2 wt % circulates 1000 times under the current density of 100 mA·g⁻¹; and blank represents the commercial aqueous diaphragm made of the PP/PE material.

### DETAILED DESCRIPTION OF THE EMBODIMENTS

The present invention is further described in detail below through combination with embodiments and the drawings, but implementation manners of the present invention are not limited to this.

Reagents and methods involved in the embodiments are all commonly used reagents and methods in the field unless stated, and any immaterial change and replacement made by those skilled in the art based on the present invention belongs to the protection scope required by the present invention.

### Embodiment 1: Preparation of Chitin-Ionic Liquid Gel and Chitin-Ionic Liquid Regenerative Hydrogel

3 g of 1-butyl-3-methylimidazolium acetate is weighed and then is put into a 25 mL eggplant-shaped flask, oil bath is performed at 100° C. for 10 min, and twin exhaust pipes are utilized for repeated air exhaust and air inflation to remove moisture and oxygen; 30 mg of dry chitin is quickly added into the above flask, oil bath is performed at 80° C., and the mixture is stirred for 3 h, so as to obtain clear and bright chitin ionic solution with 1 wt % of chitin; the chitin ionic solution is poured into a culture vessel with the diameter of 35 mm, the culture vessel is put into a dryer for natural cooling and film forming; the prepared chitin-ionic liquid gel is soaked into anhydrous ethanol for 1 h to remove most ionic liquid, then a thin film is soaked into deionized water for 24 h to thoroughly remove the ionic liquid, and the thin film is cut into a wafer with the suitable size; and the thin film is soaked into 6 M KOH solution for 3 h under the vacuum condition, so as to obtain the chitin regenerative hydrogel.

According to the above same operation, 45 mg, 60 mg and 90 mg of chitin are respectively added to prepare chitin ionic solution with 1.5 wt %, 2 wt % and 3 wt % of chitin respectively, and cooling molding and alkaline liquid replacement are performed to obtain the chitin regenerative hydrogel.

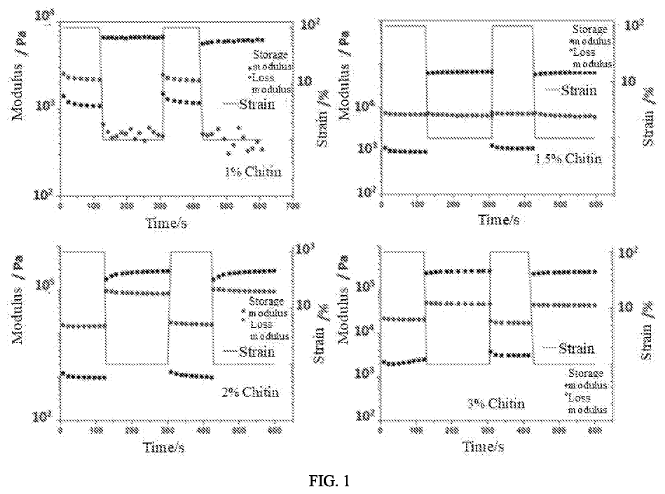

An advanced rotational rheometer is used for characterizing the gel performance of the chitin-ionic liquid gel and performing a continuous stepped deformation scanning test in a dynamic mode, and the testing frequency is 1 rad/s; and the advanced rotational rheometer maintains 120 s under 100% of strain and then maintains 180 s under 1% of strain, and the above operations are repeated once. Additionally, in order to ensure that the structure of the gel is destroyed, the maximum strain value selected in a strain step test is 100%, which is much greater than the maximum value (3%) of a linear viscoelasticity region in a dynamic strain scanning test. Results are shown as FIG. 1.

It can be seen from FIG. 1 that, when the strain amplitude is larger, the structure of the gel is destroyed (G″>G′); when the applied strain is the smaller value (1%), the structure of the gel can be restored quickly (G′>G″), and the modulus is not decreased, which indicates that the chitin-ionic liquid gel has certain restoring capacity and good thixotropy. The reasons of generating the phenomenon may be: in one aspect, a local network in chitin/[BMIM]Ac gel is not destroyed under big strain possibly, only the connection between gel networks is broken, and therefore, the chitin-ionic liquid gel can be quickly restored when the strain is decreased. In the other aspect, the ionic liquid carries charges, an imino group (—NH—) on the chitin has electropositivity, and the electrostatic force between the charges and the imino group can enable the chitin-ionic liquid gel obtained finally to have restoring capacity. Compared with a hydrogen bond, the electrostatic force is long-distance acting force, which can provide support for quick reconstruction of the structure of the gel networks, so that the deformation restoring capacity of the chitin-ionic liquid gel is improved. Additionally, due to the combined action of the hydrogen bond and the electrostatic interaction, the transient state network structure between the chitin and [BMIM]Ac can be stabilized, so as to form the physically cross-linked gel.

### Embodiment 2 Assembling of Supercapacitor by Taking Chitin Regenerative Hydrogel as Polymer Electrolyte

Preparation methods of chitin-ionic liquid gel and chitin regenerative hydrogel in the embodiment are the same as the preparation method of the chitin regenerative hydrogel in Embodiment 1.

0.85 g of TF-supercapacitor activated carbon and 0.1 g of conductive additive: Timcal graphite are weighed, and 0.05 g of PTFE concentrated emulsion and 10 mL of anhydrous ethanol are added, wherein the mass ratio of the TF-supercapacitor activated carbon, the Timcal graphite and the PTFE is 85:10:5; the mixture is uniformly stirred and then is ground for 1 h with a quartz mortar into a plasticine state, the plasticine state mixture is ground into a thin film with a glass rod, and then the thin film is cut into a wafer with the suitable size by a puncher; and the wafer is pressed on a cut foamed nickel wafer by a manual oil press with 100 Mpa of force and is dried at the temperature of 80° C. for 24 h under the vacuum condition. The total weight of a diaphragm minus the weight of a nickel sheet is multiplied by 85% which is the proportion of active substances (the TF-supercapacitor activated carbon and the conductive additive: Timcal graphite) to obtain the mass of the active substances loaded on a single electrode plate. The model of a used button capacitor is CR2032, foamed nickel electrode plates with the mass close to the active substances are selected as a group of electrodes of a supercapacitor and are soaked into 6 M KOH solution for 3 h in a vacuum environment before assembling; and the cut chitin thin film for absorbing potassium hydroxide solution is taken as a polymer electrolyte. The following tests are conducted respectively:

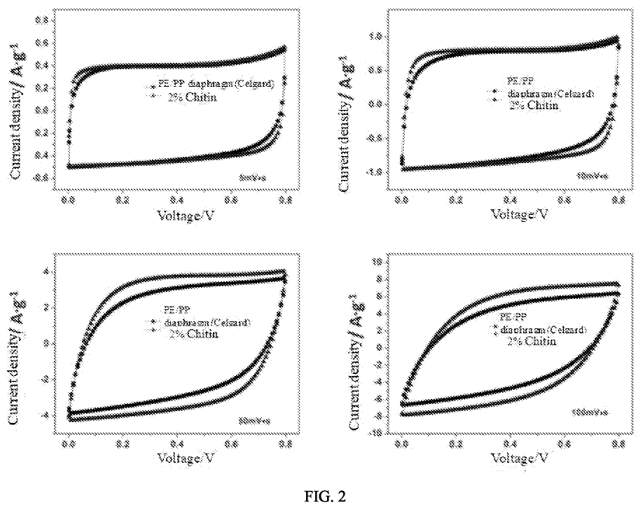

(1) A Zahner Zennium electrochemical workstation (Germany) is utilized for conducting a cyclic voltammetry test. The testing conditions are: the scanning voltage range is 0-0.8 V, the scanning rates are 5 mV/s, 10 mV/s, 50 mV/s and 100 mV/s respectively, and the scanning times are 5 times. Results are shown as FIG. 2.

A cyclic voltammetry research in FIG. 2 indicates that compared with a commercial aqueous diaphragm (Celgard) made of a PP/PE material, a chitin regenerative hydrogel diaphragm with the chitin content of 2 wt % shows higher specific capacitance and better rate capability.

(2) The Zahner Zennium electrochemical workstation (Germany) is utilized for conducting an alternating-current impedance test. The testing conditions are: the frequency is 100 KHz-100 mHz, the voltage amplitude is 5 mV, and the open-circuit voltage is 1 V.

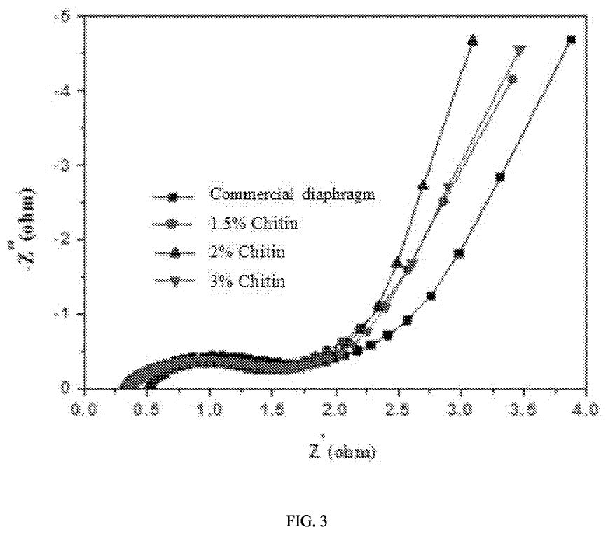

The ionic conductivity σ of the polymer electrolyte is calculated by the equation: σ=d/(SR), wherein d represents the thickness of a gel electrolyte, S represents the effective contact area of the gel electrolyte and the electrode plate, and R represents the volume resistance obtained from an alternating-current impedance spectrogram (the real axis intercept of a high frequency part of the impedance spectrogram). Results are shown as FIG. 3.

The alternating-current impedance test in FIG. 3 indicates that compared with the commercial aqueous diaphragm made of the PP/PE material, the hydrophilic nature of networks of the chitin regenerative hydrogel and the loose porous structure therein are conductive to transmission of the electrolyte therein, thereby showing greater capacitance.

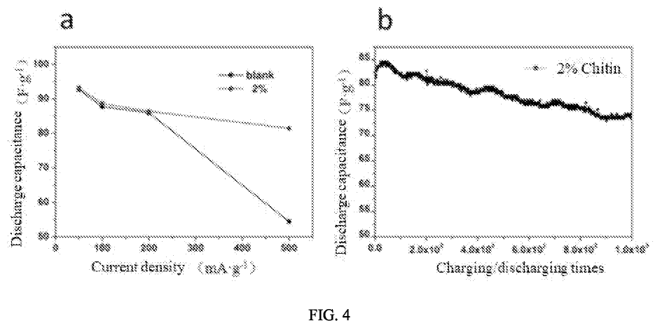

(3) The Zahner Zennium electrochemical workstation (Germany) is utilized for testing the capacitance, the rate capability and other indexes of the supercapacitor made by taking the chitin regenerative hydrogel with the chitin content of 2 wt % as the polymer electrolyte of the supercapacitor. The testing conditions are: the current densities are 0, 100 mA·g⁻¹, 200 mA·g⁻¹, 300 mA·g⁻¹, 400 mA·g⁻¹ and 500 mA·g⁻¹ respectively; and the charging/discharging times are 0, 2.0×10², 4.0×10², 6.0×10², 8.0×10² and 1.0×10³ respectively. Results are shown as FIG. 4.

It can be seen from FIG. 4a that the capacitance of the chitin regenerative hydrogel diaphragm with the chitin content of 2 wt % is 92 F·g⁻¹ under the working current of 50 mA·g⁻¹, the rate retention rate is 92% under the current density of 500 mA·g⁻¹, which are the same as the results of the above cyclic voltammetry test and the above alternating-current impedance test and indicate that the chitin regenerative hydrogel diaphragm prepared in the present invention has better rate retention performance.

The results in FIG. 4b indicate that compared with the commercial aqueous diaphragm made of the PP/PE material, the discharge capacity of the supercapacitor made by taking the chitin regenerative hydrogel with the chitin content of 2 wt % as the polymer electrolyte of the supercapacitor is attenuated more slowly with the increase of the charging/discharging times.

### Embodiment 3 Preparation of Chitin-Ionic Liquid Gel and Chitin-Ionic Liquid Regenerative Hydrogel

Preparation methods of chitin-ionic liquid gel and chitin-ionic liquid regenerative hydrogel in the embodiment are the same as the preparation method in Embodiment 1, and the differences are that: in the embodiment, the temperature of oil bath heating before mixing of ionic liquid and chitin is 120° C., and the time of oil bath heating is 12 min; the temperature of oil bath heating of chitin and 1-ethyl-3-methylimidazolium acetate ([EMIM]Cl) is 70° C., and the time of oil bath heating is 2 h; the time of soaking the prepared chitin-ionic liquid gel with an alcohol solvent is 0.5 h, and the time of soaking the prepared chitin-ionic liquid gel with distilled water is 18 h; and the prepared chitin-ionic liquid gel is soaked into LiOH with the concentration of 8 M for 4 h.

The chitin regenerative hydrogel with good performance, which is as described in Embodiment 1, is also prepared by the above method.

### Embodiment 4 Preparation of Chitin-Ionic Liquid Gel and Chitin-Ionic Liquid Regenerative Hydrogel

Preparation methods of chitin-ionic liquid gel and chitin-ionic liquid regenerative hydrogel in the embodiment are the same as the preparation method in Embodiment 1, and the differences are that: in the embodiment, the temperature of oil bath heating before mixing of ionic liquid and chitin is 80° C., and the time of oil bath heating is 8 min; the temperature of oil bath heating of chitin and 1-allyl-3-methylimidazolium bromide ([AMIM]Br) is 60° C., and the time of oil bath heating is 1 h; the time of soaking the prepared chitin-ionic liquid gel with an alcohol solvent is 2 h, and the time of soaking the prepared chitin-ionic liquid gel with distilled water is 12 h; and the prepared chitin-ionic liquid gel is soaked into NaOH with the concentration of 3 M for 2 h.

The chitin regenerative hydrogel with good performance, which is as described in Embodiment 1, is also prepared by the above method.

The above embodiments are better implementation manners of the present invention, but the implementation manners of the present invention are not limited by the above embodiments. Any other changes, modifications, replacements, combinations and simplifications made without departing from the spiritual essence and the principle of the present invention should be equivalent substitutions and shall be concluded in the protection scope of the present invention.

What is claimed is:

1. A preparation method of chitin regenerative hydrogel, comprising the following steps:
S1, performing heating dissolution and cooling molding on chitin and ionic liquid to obtain chitin-ionic liquid gel;
S2, soaking the chitin-ionic liquid gel into alkaline solution to obtain the chitin regenerative hydrogel.

2. The preparation method according to claim 1, wherein in the step S1, the chitin is from at least one of shrimp shells and crab shells.

3. The preparation method according to claim 1, wherein in the step S1, the ionic liquid is at least one of 1-butyl-3-methylimidazolium acetate, 1-ethyl-3-methylimidazolium acetate and 1-allyl-3-methylimidazolium bromide.

4. The preparation method according to claim 1, wherein in the step S1, the mass ratio of the chitin and the ionic liquid is 0.5-5:100.

5. The preparation method according to claim 1, wherein in the step S1, the heating refers to oil bath heating; the temperature of the oil bath heating is 60-80° C., and the time of the oil bath heating is 1-3 h.

6. The preparation method according to claim 1, wherein in the step S2, the alkaline solution is at least one of potassium hydroxide solution, LiOH solution and sodium hydroxide solution.

7. A chitin regenerative hydrogel, which is prepared by the preparation method of claim 1.

8. An application of the chitin regenerative hydrogel of claim 7 in an energy material.

9. An application of the chitin regenerative hydrogel of claim 7 in a polymer electrolyte.

10. A supercapacitor, taking the chitin regenerative hydrogel of claim 7 as the polymer electrolyte.
